(19) United States
(12) Patent Application Publication
(10) Pub. No.: US 2010/0219708 A1
(43) Pub. Date: Sep. 2, 2010

(54) MECHANICAL ENERGY MODULE

(76) Inventor: Thomas Earl Clark, Saint Louis, MO (US)

Correspondence Address: Quaker Consulting LLC, 6822 Wynfield Terrace Drive, Saint Louis, MO, 63129-3975, US

(21) Appl. No.: 12/714,512

(22) Filed: Feb. 28, 2010

Related U.S. Application Data
(60) Provisional application No. 61/156,656, filed on Mar. 2, 2009.

(51) Int. Cl. H02K 21/00; H02N 11/00

(52) U.S. Cl. 310/152; 415/916

(57) ABSTRACT

An energy module utilizing permanent magnets arranged on a moveable inner shaft (33) which interact with an arrangement of permanent magnets on a rotating outer shaft (32) thereby producing torque. By moving the inner shaft (33) in and out of the rotating outer shaft (32) magnets, a continuous rotation is achieved which is similar in function to an electric motor while mainly using the power of permanent magnets. A magnetic energy advantage is created since the power to move the moveable inner shaft (33) is less than the power output of the torque generated on the rotating outer shaft (32).

### CROSS-REFERENCE TO RELATED APPLICATIONS

This application claims the benefit of PPA Ser. No. 61/156,656, filed 2009 Mar. 2 by the present inventor.

### FEDERALLY SPONSORED RESEARCH

Not applicable

### SEQUENCE LISTING OR PROGRAM

Not applicable

### BACKGROUND OF THE INVENTION

1. Field of Invention

This invention generally relates to a new method of producing power, specifically to an energy module which is similar in operation to an electric motor.

2. Prior Art

Previously electric motors have permanent magnets in a fixed position with an armature and windings of wire that rotate between the permanent magnets. When electricity is sent through the windings of the armature, the magnetic field produced serves as a repulsion or attraction to the permanent magnets, thus causing rotation of the armature and shaft, producing a torque which is used for power.

### OBJECTS AND ADVANTAGES

Accordingly, several objects and advantages of the invention are in conflict with current thinking concerning the thermodynamics laws, which indirectly conclude that a machine cannot have a power output greater than the power input, in other words an efficiency of greater than 100 percent. However, my experience with the current prototype shows that the arrangement of the invention as described here produces what I call a magnetic energy advantage. This magnetic energy advantage is obtained by moving magnets on a moveable structure into a structure with magnets as well but will rotate when the magnets from the moveable structure enter the center of the magnet arrangement on the rotating structure, creating a torque. My theory is holding to be true so far when testing the invention as described. The basic idea is that the power to manipulate the moveable structure in and out of the magnetic field(s) of the rotating structure does not significantly increase when you add more magnets or larger magnets to the rotating structure, or you add more rotational disks with magnets. However, by adding more rotational disks and/or magnets, or by adding more powerful magnets the output power of the subject invention will rise at a greater magnitude than the power input requirements to manipulate the moveable structure with magnets attached. Thus at some point the output will be greater than the input power required. I fully realize that such an invention will require a working model, due to the potential novelty. By the time this patent is examined I plan to have my prototype complete and ready for examination. If for some reason this claim is rejected, the second claim asserts a machine that could substitute for an electric motor and not requiring the typical wiring etc. thus making the subject invention less costly, as well as utilizing for the most part only permanent magnets to produce the power.

### SUMMARY

In accordance with the present invention a novel way of producing mechanical power whereby the power output is greater than the power input.

### DRAWINGS—FIGURES

FIG. 1 is a side cut away view of the subject invention showing the lateral movement of the inner shaft 33 with respect to the outer shaft 32 as well as the other energy module parts depicted in the preferred embodiment of the invention.

FIG. 2 is and end view showing the placement of the outer shaft magnets 6 and 8 on the outer shaft 32, the inner shaft 33 with the inner shaft magnets 7. The inner shaft 33 actually has 4 magnets as depicted in FIG. 1 and the outer shaft supports 21. The bearing between the outer shaft support 21 and the outer shaft 32 is depicted in bearing 23. The inner shaft spline 25 serves to keep the inner shaft 33 from rotating and to allow for horizontal movement within the outer shaft 32. The magnet cap 4 is a threaded cap screwed into the magnet cavity to hold the magnet in place and is not depicted in FIG. 1 or FIG. 4 because I wanted to show the more important parts which were the magnets and their north or south poles.

FIG. 3 is an end view showing the relationship to the inner shaft spline 25 for the inner shaft 33 and the inner shaft support 26 along with support base 29. It also shows the inner shaft magnet(s) 7 with magnet cap 4.

FIG. 4 is a cutaway view similar to FIG. 1 but shows the inner shaft magnets 7 in a position so as to not create torque on the outer shaft 32. Interrupter material 3 is also shown in a position 180 degrees in rotation from the depiction in FIG. 1 so the inner shaft 33 would be held in a position where linear actuator 27 is disengaged and spring 9 is holding inner shaft 33 in this position.

DRAWINGS--Reference Numerals

| | | | |
|---|---|---|---|
| 1 | Optical interrupter switch | 2 | Flywheel |
| 3 | Interrupter material | 4 | Magnet cap |
| 5 | Inner shaft supports | 6 | Outer shaft magnets |
| 7 | Inner shaft magnets | 8 | Outer shaft magnets |
| 9 | Spring | 10 | Collar |
| 11 | Outer shaft support | 12 | Starter |
| 13 | Starter gear | 14 | Outer shaft gear |
| 15 | Starter wires | 16 | Generator |
| 17 | Generator output terminals | 18 | Outer shaft gear |
| 19 | Generator gear | 20 | Generator shaft |
| 21 | Outer shaft support | 22 | Linear actuator connections |
| 23 | Bearing | 24 | Linear actuator plunger |
| 25-25a | Inner shaft spline | 26 | Inner shaft support |
| 27 | Linear actuator | 28 | Linear actuator supports |
| 29 | Support base | 30 | Power supply |
| 31 | Starter switch | 32 | Outer shaft |
| 33 | Inner shaft | 34 | Attaching bolts |
| 35 | Support bases | 36 | Generator support base |
| 37 | Starter support bases | 38 | Support bases |
| 39 | Optical interrupter | | |
| | switch support | | |

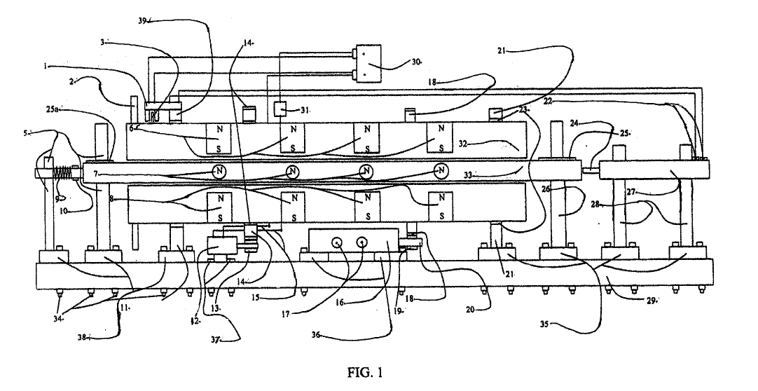

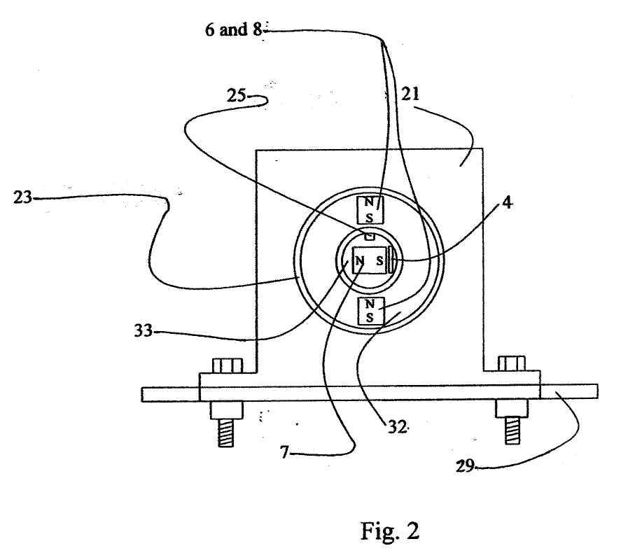

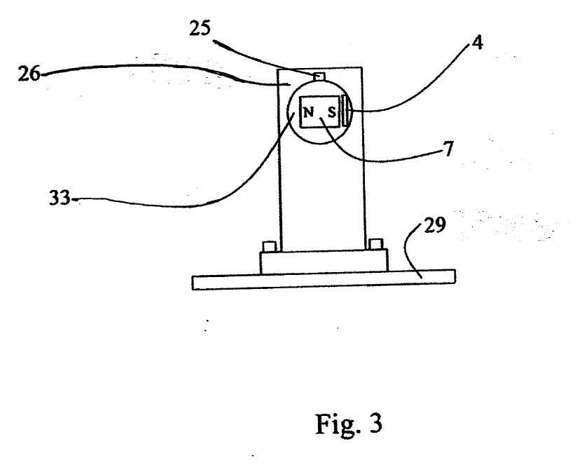

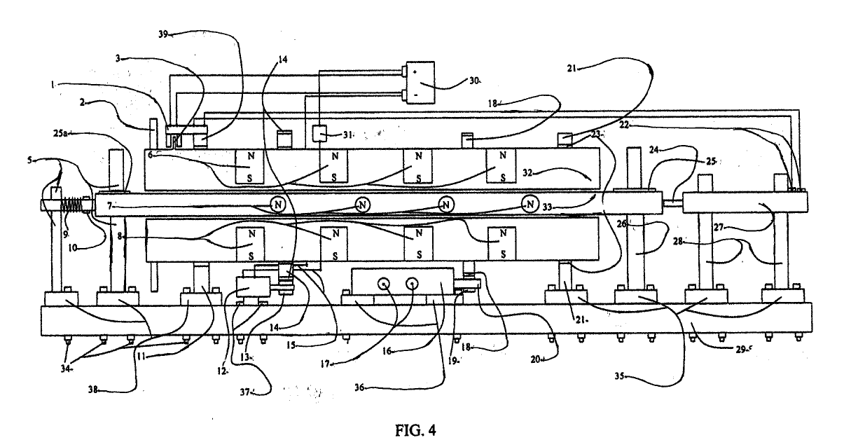

### DETAILED DESCRIPTION—FIGS. 1, 2, 3, 4—PREFERRED EMBODIMENT

Power supply 30 has connection for the starter 12 and optical interrupter switch 1. Starter gear 13 meshes with outer shaft gear 14 allowing starter 12 to rotate the outer shaft 32. Starter switch 31 engages and disengages the starter 12. Optical interrupter switch 1 is linked to linear actuator 27. Interrupter material 3 is connected to outer shaft 32. Outer shaft 32 rotates and causes the interrupter material 3 to pass through optical interrupter switch 1 causing an electrical signal to be sent to linear actuator 27. Linear actuator 27 uses the electrical power to force linear actuator plunger 24 in a horizontal motion thus pushing inner shaft 33. Inner shaft 33 moves horizontally compressing spring 9. Inner shaft magnets 7 will be in various positions with respect to the outer shaft magnets 6 and 8 as the inner shaft 33 moves horizontally. Inner shaft spline 25 and 25a cause the inner shaft 7 to stay in alignment and thus not to rotate as it moves horizontally, thus keeping the inner shaft magnets 7 in a horizontal position with the north/south poles in a horizontal position at all times. The inner shaft magnets 7 are placed in the inner shaft 33 in drilled holes having threaded caps on both ends of the holes which serve to hold the inner shaft magnets 7 in place. Outer shaft magnets 6 and 8 are aligned in 4 pairs and have their north/south poles aligned as indicated. The outer shaft magnets 6 and 8 create a magnetic field crossing the inner shaft 33 since one of the outer shaft magnets 6 and 8 has a north pole facing toward the inner shaft 33 and the other magnet opposing it has it's south pole facing toward the inner shaft 33. The outer shaft magnets 6 and 8 are placed in drilled holes of the appropriated diameter with magnet caps 3 holding the outer shaft magnets 6 and 8 in place. The holes for the outer shaft magnets 6 and 8 in the outer shaft 32 are drilled so there is some material left in the outer shaft 32 inside face. This allows for the magnetic field to be created between each magnet pair in the outer shaft 32 and prevents them from actually moving together because of the attracting magnetic poles facing each other on each magnet pair. Outer shaft gear 18 meshes with generator gear 19 so when the outer shaft 19 rotates the generator shaft 20 rotates to create the electrical power output of the invention to the generator output terminals 17. Flywheel 2 gives the machine momentum as it rotates between the cycles of the optical interrupter switch 1 sending signals to the linear actuator 27. Support base 29 serves as the foundation for the invention as depicted. Bearing 23 serves to allow the free rotation of outer shaft 32 within the outer shaft support 21 and outer shaft support 11.

### OPERATION—FIGS. 1, 2, 3, 4

The starter switch 31 is closed, sending electricity through starter wires 15 from power supply 30 causing starter 12 to rotate. Starter gear 13 is meshed with outer shaft gear 14 causing rotation of outer shaft 32. After one revolution the starter switch 31 is disengaged. One revolution of outer shaft 32 will have occurred when the interrupter material 3 has moved through optical interrupter switch 1 for a complete revolution. The starter 12 is then disengaged. After outer shaft 32 rotation begins, the interrupter material 3 passes through the optical interrupter switch 1 causing electricity to flow to the linear actuator 27 via the linear actuator connections 22 causing the inner shaft 33 to be moved horizontally and aligning the inner shaft magnets 7 with the outer shaft magnets 6 and 8 with the magnetic fields of the inner shaft magnets 7 having their magnetic fields being 90 degrees with respect to the outer shaft magnetic fields. The torque generated is a function of the strength of the magnetic field between the two opposing magnets in the outer shaft 32 and the strength of the magnetic field on the inner shaft magnets 7, as well as the distance between the magnet on the inner shaft 33 and the respective magnets on the outer shaft 32 along with the angle between the inner shaft magnets 7 and the outer shaft magnets 6 and 8. Rotation of the outer shat 32 is then accomplished by the torque produced when the inner shaft magnets 7 are placed in the magnetic field between the corresponding pair of outer shaft magnets 6 and 8. Since the inner shaft 33 has splines 25 and 25a at each end which move through the inner shaft supports 26 and 5, the inner shaft 33 does not rotate, therefore the torque produced causes the outer shaft 32 to rotate. The inner shaft 33 is in the position to cause rotation of the outer shaft 32 momentarily, then when the optical interrupter switch 1 ceases to cause electricity to flow to the linear actuator 27 the spring 9 on the inner shaft 33 will cause the inner shaft 33 to return to it's original position. The torque will no longer be produced when the inner shaft 33 returns to it's original position. When the outer shaft 32 rotates one complete revolution, the interrupter material 3 again passes through the optical interrupter switch 1 and starts the cycle over. The flywheel 2 will act to create momentum which will cause the revolution of outer shaft 32 to continue to the next cycle. This momentum will increase as the speed of outer shaft 32 increases. As outer shaft 32 rotates the outer shaft gear 18 meshes with the generator gear 19 which causes generator shaft 20 to rotate. As generator shaft 20 rotates, electrical output is generated via generator 16. The electrical output is then transferred to whatever load may be attached via the generator output terminals 17. The direction of rotation of outer shaft 32 depends on the orientation of the inner shaft magnets 7. In FIG. 1 the north pole of the inner shaft magnets 7 are to the left with respect to the end view looking at the linear actuator 27. If the inner shaft magnets had the reverse orientation the resulting rotation of outer shaft 32 would be reversed. Collar 10 holds spring 9 in place so when inner shaft 33 moves the spring 9 will provide force to move inner shaft 33 back to it's original position. Outer shaft 32 is held by outer shaft supports 11 and 21 and rotates on outer shaft bearings 23 at both ends of outer shaft. Linear actuator is supported by linear actuator supports 28. The support base 29 serves to support the necessary elements of the subject invention. Attaching bolts 34 serve to secure the various elements of the subject invention to the support base 29. Support bases for the various elements are depicted in 35 and 38 which serve to secure the various elements to the support base 29. Generator 16 is supported by the generator support bases 36. Starter 12 is supported by starter support bases 37. Optical interrupter switch 1 is supported by optical interrupter switch support 39.

### DESCRIPTION—ALTERNATIVE EMBODIMENT—FIGS.

Not applicable

### OPERATION—ALTERNATIVE EMBODIMENT—FIGS.

Not applicable

### CONCLUSION, RAMIFICATIONS, AND SCOPE

Accordingly the reader will see that, according to the invention, I have provided a novel way of producing power which will revolutionize the power industry as well as provide mobile power for a multitude of uses.

While the above description contains many specificities, these should not be construed as limitations on the scope of the invention, but as exemplifications of the presently preferred embodiments thereof. Many other ramifications and variations are possible within the teaching of the invention. For example, larger outer/inner shafts containing more powerful magnets, a larger circumference on the outer shaft, different means for actuating other than a linear actuator, other various arrangements of the inner/outer shafts and support base, different nomenclature for the output device such as alternator vs generator, and many others.

Thus the scope of the invention should be determined by the appended claims and their legal equivalents, and not by the examples given.

I claim:

1. A mechanical energy module comprising:
(a) a moveable structure having means of connection to a source for creating force and thus movement of said moveable structure,
(b) a plurality of magnets having means of attaching said plurality of magnets to said moveable structure,
(c) a rotating structure,
(d) a second plurality of magnets, having means of attaching said second plurality of magnets to said rotating structure in a manner which orients the magnetic fields of said second plurality of magnets so that 180 degrees of said rotating structure has north magnetic poles pointing to the center of said rotating structure with the remaining 180 degrees of said rotating structure having the remainder of said second plurality of magnets having their south magnetic poles pointing to the center of said rotating structure, while said moveable structure along with said plurality of magnets being moved into the center of said second plurality of magnets whereby the magnetic fields of said plurality of magnets have their magnetic fields oriented at right angles to the magnetic fields of said second plurality of magnets causing a torque to be created, said rotating structure having means of attaching to a power output device, while the power for manipulating said moveable structure is less than the torque created on said rotating structure,
whereby the power output of said mechanical energy module is greater than the power input to the said mechanical energy module.

2. A mechanical energy module comprising:
(a) a moveable structure having means of connection to a source for creating force and thus movement of said moveable structure,
(b) a plurality of magnets having means of attaching said plurality of magnets to said moveable structure,
(c) a rotating structure,
(d) a second plurality of magnets, having means of attaching said second plurality of magnets to said rotating structure in a manner which orients the magnetic fields of said second plurality of magnets so that 180 degrees of said rotating structure has north magnetic poles pointing to the center of said rotating structure with the remaining 180 degrees of said rotating structure having the remainder of said second plurality of magnets having their south magnetic poles pointing to the center of said rotating structure, while said moveable structure along with said plurality of magnets being moved into the center of said second plurality of magnets, where the magnetic fields of said plurality of magnets have their magnetic fields oriented at right angles to the magnetic fields of said second plurality of magnets causing a torque to be created, said rotating structure having means of attaching to a power output device, while the power for manipulating said moveable structure is less than the resultant torque created on the said rotating structure,
whereby said mechanical energy module will serve as a power source while using the interaction of said moveable structure with said plurality of magnets along with sufficient power to move said moveable structure with said plurality of magnets, with the said second plurality of magnets creating a torque to be used to power said rotating structure with means to attach said rotating structure to an output device.
